(19) United States
(12) Patent Application Publication
(10) Pub. No.: US 2010/0275204 A1
(43) Pub. Date: Oct. 28, 2010

(54) COMPUTING MACHINE

(76) Inventors: Koichiro Kamura, Fujisawa-shi (JP); Tatsuya Kurozumi, Hachioji-shi (JP); Tsutomu Rokuhara, Tama-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/761,817

(22) Filed: Apr. 16, 2010

(30) Foreign Application Priority Data
Apr. 28, 2009 (JP) 2009-110091

(51) Int. Cl. G06F 9/44

(52) U.S. Cl. 718/1

(57) ABSTRACT

According to one embodiment, a computing machine includes virtual machines configured to simultaneously run on a virtual machine monitor, wherein the virtual machines comprises a user virtual machine, a first virtual machine, and a second virtual machine, the user virtual machine is configured to execute an application program and an operating system, the first virtual machine is configured to provide a shared folder to the user virtual machine, the user virtual machine comprises a specific information storage module configured to store specific information includes system data in the second virtual machine, and the user virtual machine comprises setting data for storing use data of the user virtual machine in the shared folder.

### CROSS-REFERENCE TO RELATED APPLICATIONS

This application is based upon and claims the benefit of priority from Japanese Patent Application No. 2009-110091, filed Apr. 28, 2009, the entire contents of which are incorporated herein by reference.

### BACKGROUND

1. Field

One embodiment of the invention relates to a computing machine comprising a plurality of virtual machines configured to run at the same time.

2. Description of the Related Art

It is required to efficiently perform operations such as version upgrade of security patch and application program in a virtual machine environment.

Jpn. Pat. Appln. KOKAI Publication No. 2008-84029 discloses a virtual machine management system, in which an image file of a guest operating system is unifiedly managed by a host operating system as a master guest operating system image, and writing/reading of data on the guest operating system created by copying the master guest operating system is redirected to a virtual application image file to separate a guest operating system image and a virtual application image.

The above document discloses the management of an application program. The guest operating system image needs to be prepared for network configuration information and a machine name with respect to each user. As a result, it is necessary to prepare a plurality of guest operating system images, which requires many disk resources.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing an example of a system configuration of a computing machine according to one embodiment of the present invention;

FIG. 2 is a block diagram showing the system configuration of the computing machine according to one embodiment of the present invention;

FIG. 3 is a view used in describing an operation of creating a master image by the computing machine according to one embodiment of the present invention;

FIG. 4 is a view to explain an operation of receiving the master image of the computing machine according to one embodiment of the present invention; and

FIG. 5 is a view showing a modification of the system of the computing machine according to one embodiment of the present invention.

### DETAILED DESCRIPTION

Various embodiments according to the invention will be described hereinafter with reference to the accompanying drawings. In general, according to one embodiment of the invention, a computing machine comprising virtual machines configured to simultaneously run on a virtual machine monitor, wherein the virtual machines comprises a user virtual machine, a first virtual machine, and a second virtual machine, the user virtual machine is configured to execute an application program and an operating system, the first virtual machine is configured to provide a shared folder to the user virtual machine, the user virtual machine comprises a specific information storage module configured to store specific information comprising system data in the second virtual machine, and the user virtual machine comprises setting data for storing use data of the user virtual machine in the shred folder.

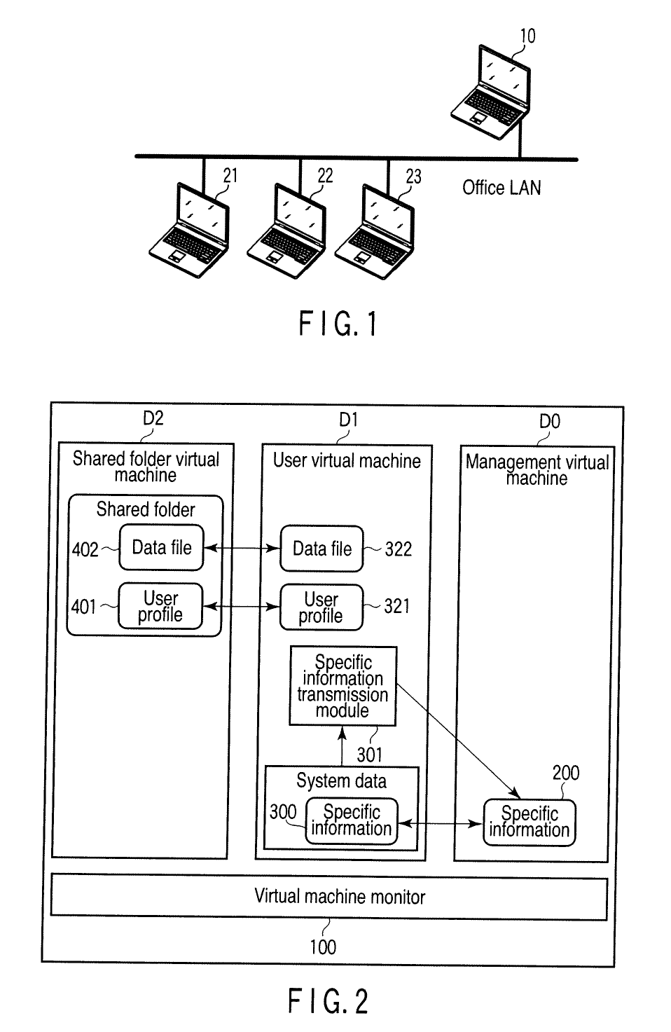

FIG. 1 shows an example of a system configuration of a computing machine according to one embodiment of the present invention. The system comprises a computing machine 10 which creates a master image to execute a user virtual machine and distributes the image, and a plurality of computing machines 21 to 23 which receive the master image.

Computing machines 10 and 21 to 23 are implemented by notebook personal computers.

FIG. 2 shows a system configuration of the computing machines (10 and 21 to 23) according to one embodiment of the present invention.

As shown in FIG. 2, a virtual machine monitor (VMM) 100, and virtual machines D0 to D2 run on the computing machine. The virtual machines D0 to D2 can simultaneously run on the virtual machine monitor 100. In addition, each virtual machine can exchange data with another virtual machine through the virtual machine monitor. The virtual machine monitor 100 logically divides a computational resource such as a processor, memory, and hard disk drive into a plurality of resources and allocates the virtual machines D0 to D2 to the divided computational resources.

For example, an operating system such as Windows (registered trademark) used when a user executes an application program such as a word processor and a spreadsheet program is installed on the user virtual machine D1. In addition, the management virtual machine D0 is a virtual machine called “DOMAIN0” in general. Linux 0 is installed on the management virtual machine D0 as an operating system, and an application program runs on Linux to boot/shutdown the virtual machines D1 and D2, to allocate a virtual hard disk and a virtual memory, and to configure a virtual network.

In addition, the virtual machine D0 comprises a data storage region to store specific information 200 regarding the operating system and the application settings which are specific to the user of the virtual machine D1, such as a computer name and network configuration information of the virtual machine D1. The specific information is recorded in a file known as a registry file, for example. In the case of Windows, for example, the registry file is stored in a lower folder of a system folder (% SystemRoot %\System32) in % SystemRoot %\System32\Config.

In addition, the user virtual machine D1 comprises a specific information transmission module 301. The specific information transmission module 301 has functions to transmit specific information 300 to the virtual machine D0 and store the specific information 200 of the user virtual machine D1 in the management virtual machine D0 when the settings in the specific information 300 is changed or when the user of the user virtual machine D1 logs off or shutdown.

Moreover, the virtual machine D2 has a function to provide a shared folder service to the virtual machine D1. A data file 321 (data file stored in “My Documents” in the case of Windows) created and edited by the user and a user profile 322 are stored in the shared folder prepared by the shared folder service. The user profile 322 is a file (folder) to record information regarding a system environment of each user.

The operating system of the virtual machine D1 sets a “My Documents” folder and a profile folder in the shared folder as paths of the “My Documents” and the user profile 322. The operating system running in the user virtual machine D1 refers to the shared folder stored in the shared folder virtual machine D2, and reads personal settings (user profile) from the shared folder when the user logs in. In the case of Windows, the path of the user profile 322 is recorded in the registry file. Therefore, when the path showing the user profile 322 in the shared folder of the shared folder virtual machine D2 is previously registered in the registry file, the operating system of the user virtual machine can automatically acquire the user profile 322.

In addition, in this embodiment, the data stored in the data file 321 which is edited with the application program stored in “My Documents” and stored in the user profile 322 is referred to as user data.

In addition, the user virtual machine D1 has a function to make it look as though the data file 321 exists on a local disk of the user virtual machine D1 when the user reads and writes a data file 401 in the shared folder provided by the shared folder virtual machine D2 by previously setting the specific folder (may be a partition) of the local disk of the virtual machine D1 as a target folder of “My Documents”.

As described above, the computing machine according to one embodiment of the present invention is characterized in that the three virtual machines D0 to D2 simultaneously run, and the specific information 300 of the user virtual machine D1 is stored in the management virtual machine D0, and the user data of the user virtual machine D1 is stored in the shared folder virtual machine D2. In this configuration, the specific computing machine creates the master image for the virtual machine D1, and when this master image is copied in another computing machine and developed, the personal information and the user data can be preserved.

Hereinafter, a description will be made of an operation from the creation to the development of the master image.

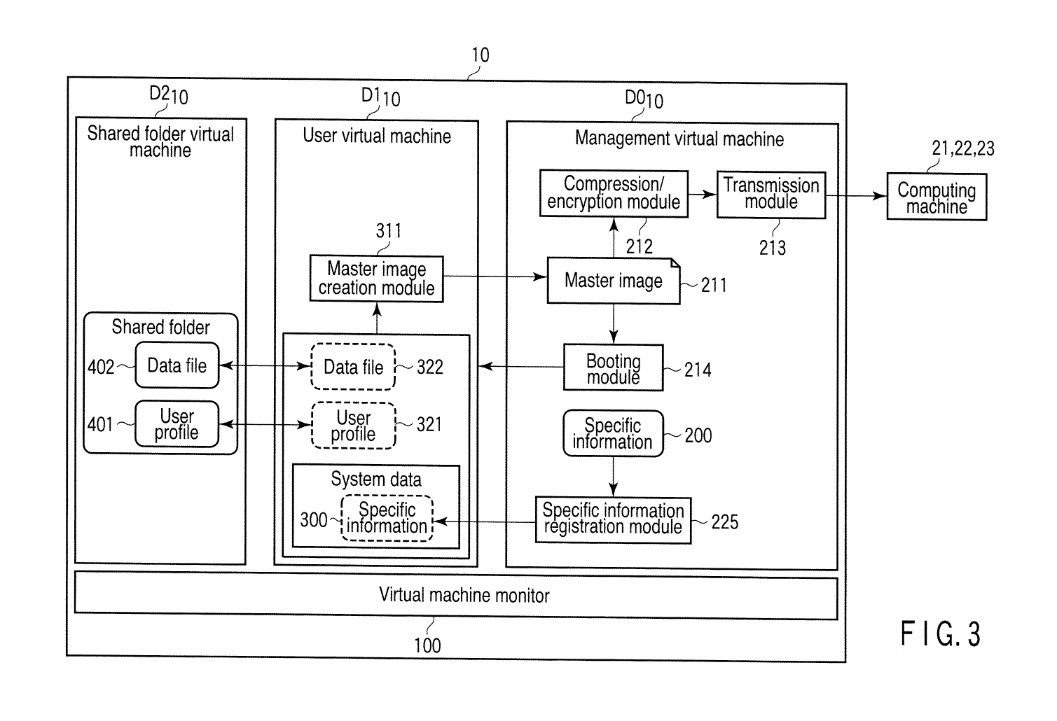

The operation of the image creation of computing machine 10 according to one embodiment of the present invention will be described with reference to FIG. 3.

As shown in FIG. 3, a user virtual machine D1₁₀ running on the master image creation computing machine 10 comprises a master image creation module 311. In addition, a management virtual machine D0₁₀ running on the master image creation computing machine 10 comprises a compression/encryption module 212 and a transmission module 213.

The master image creation module 311 in the user virtual machine D1₁₀ has a function (sharing) to create a master image 211 which excludes the user data and the specific information 300 in the system data of the user virtual machine D1₁₀. In addition, the master image creation module 311 transmits the master image 211 to the management virtual machine D0₁₀ after creating the master image. After completing the transmission, the master image creation module 311 notifies the management virtual machine D0₁₀ of the fact that it will shut down the user virtual machine D1₁₀, and performs a process of shutting down the user virtual machine D1₁₀.

In addition, the system data used herein means the data file, driver, and specific information required to boot the operating system and the application.

The transmission module 213 running in the management virtual machine D0₁₀ has a transmission function to transmit the master image 211 to the other computing machines 21, 22, and 23 through the network when it detects that the user virtual machine D1₁₀ has been shut down after receiving the notice from the virtual machine D. Note that the master image may be compressed or encrypted by the compression/encryption module 212 before the transmission module 213 transmits the master image.

After the transmission, an booting module 214 boots the user virtual machine D1₁₀, with the master image. A specific information registration module 215 registers the specific information 300 in the user virtual machine D1₁₀. The specific information is registered by storing the specific information 200 in the path storing the specific information 300 originally. The operating system in the user virtual machine D1₁₀ reads the specific information 300. After that, the operating system in the user virtual machine D1₁₀ performs a process of mounting a shared folder provided by a shared folder virtual machine D2₁₀. Thus, after the transmission, the configuration is the same as that before the image is created, and can be used by the user in the same manner as before the image creation.

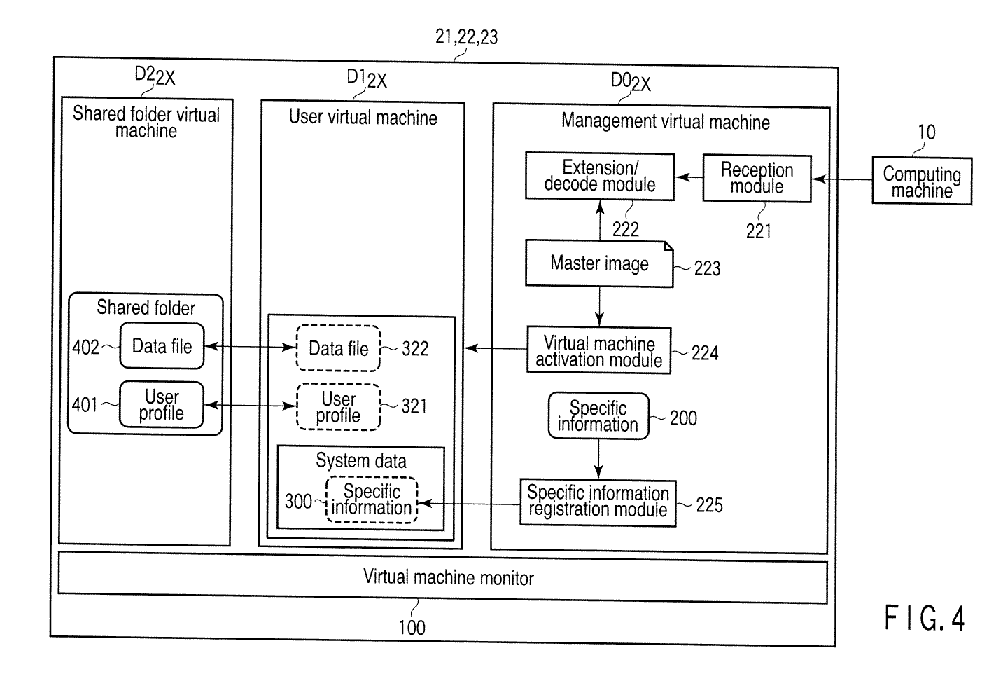

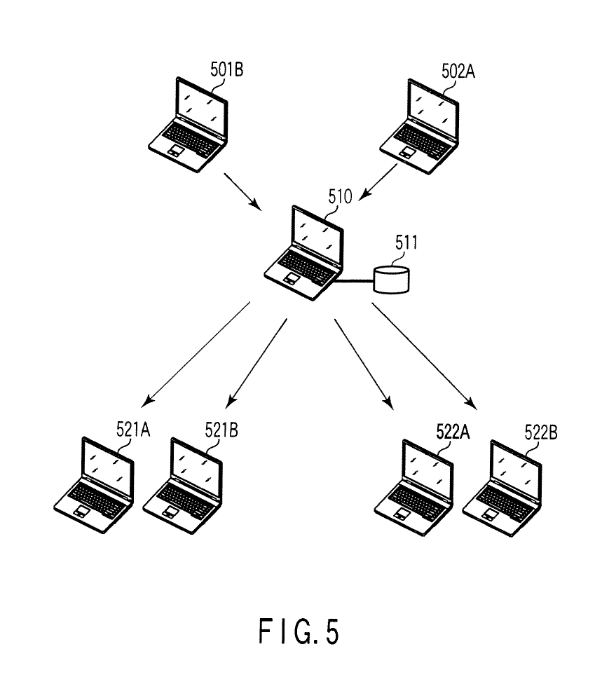

Next, a description will be made of an operation of master image reception by computing machines 21 to 23 according to one embodiment of the present invention with reference to FIG. 4.

A management virtual machine D0_{2X} in computing machines 21 to 23 comprises a reception module 221, an extension/decode module 222, a virtual machine booting module 224, and a specific information registration module 225.

The reception module 221 receives the data of the encrypted and compressed master image from computing machine 10. The extension/decode module 222 creates a master image 223 by extending and decoding data m received by the reception module 221. The virtual machine booting module 224 boots a user virtual machine D1_{2X} with the master image 223. The specific information registration module 225 registers the specific information 200 in the user virtual machine D1_{2X}. The operating system in the user virtual machine D1₁₀ reads the specific information. After that, the operating system in the user virtual machine D1₁₀ performs a process of mounting a shared folder provided by a shared folder virtual machine D2₁₀. In this configuration, after the transmission, the configuration is the same as before the image is created, and can be used by the user in the same manner as before the image creation.

According to this embodiment, since the user data and the specific information of the machine are stored in the other virtual machine, the user data and the specific information before updated can be restored by connecting the user data and the specific information again after receiving the master image created by the other computing machine and then updating the operating system and the application contained in the master image.

As a result, since the master image to be prepared is only one, the disk resource does not increase. In addition, the system environment of the computing machine such as the operating system and the application can be unifiedly managed and shared by the workgroup such as a section and a kind of occupation. Thus, the operations such as application of security patch and version update of the application which have been performed by the administrator or user with respect to each personal computer conventionally can be simply performed by the administrator with his/her own personal computer, so that all the supervised personal computers can be kept in an updated usage environment. As a result, the operation management burden can be reduced throughout the life cycle of the personal computer, and company risk threatened by the personal computer whose security is vulnerable can be reduced.

In addition, the image is transmitted from the image creation computing machine to the target computing machine in the above embodiment. Meanwhile, as shown in FIG. 5, a configuration may be composed of a plurality of image creation computing machines 501A and 501B, a master image distributing computing machine 510, and a plurality of master image receiving computing machines 521A, 521B, 522A, and 522B. In the case shown in FIG. 5, computing machines 501A, 521A, and 521B use the same hardware, and computing machines 501B, 522A, and 522B use the same hardware. Thus, computing machine 501A creates a master image for computing machines 521A and 521B. In addition, computing machine 501B creates a master image for computing machine 522A and 522B.

Computing machines 501A and 501B store the created master images in a hard disk drive 511 published on the network. Thus, computing machine 510 transmits the master image created by computing machine 501A to computing machines 521A and 521B. In addition, computing machine 510 transmits the master image created by computing machine 501B to computing machines 522A and 522B.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computing machine comprising virtual machines configured to simultaneously run on a virtual machine monitor:
wherein the virtual machines comprises a user virtual machine, a first virtual machine, and a second virtual machine,
the user virtual machine is configured to execute an application program and an operating system,
the first virtual machine is configured to provide a shared folder to the user virtual machine,
the user virtual machine comprises a specific information storage module configured to store specific information comprising system data in the second virtual machine, and
the user virtual machine comprises setting data for storing use data of the user virtual machine in the shred folder.

2. The computing machine of claim 1, wherein the virtual machines comprises a third virtual machine,
the third virtual machine comprises:
a master image acquisition module configured to acquire a master image to be run the user virtual machine; and
a booting module configured to boot the user virtual machine with the master image acquired by the master image acquisition module and to store the specific information in the specific information storage module in the user virtual machine.

3. The computing machine of claim 1, wherein the specific information comprises a machine name and network configuration information.

4. The computing machine of claim 1, wherein the specific information comprises a registry file stored in a system folder.

5. A computing machine comprising virtual machines configured to simultaneously run on a virtual machine monitor,
wherein the virtual machines comprises a user virtual machine and a first virtual machine,
the user virtual machine is configured to execute an operating system,
the user virtual machine comprises a master image creation module configured to create a master image for running the user virtual machine, the a master image excluding a specific information contained in system data and user data, and
the first virtual machine comprises a transmitting module configured to transmit the master image created by the master image creation module to another computing machine.

6. The computing machine of claim 5, wherein the specific information comprises a machine name and a network configuration information.

7. The computing machine of claim 5, wherein the specific information comprising a registry file stored in a system folder.

8. The computing machine of claim 7, wherein the specific information comprises a machine name and a network configuration information.

9. A method of controlling a computing machine, comprising:
creating, by a first computing machine, a master image for executing a user virtual machine and excluding user data and specific information contained in system data, wherein the first computing machine comprises virtual machines comprising the user virtual machine to execute an application program and an operating system, and the virtual machines are configured to simultaneously run in the first computing machine;
transmitting the master image from the first computing machine to a second computing machine which comprises second virtual machines configured to simultaneously run, the second virtual machines comprising a first virtual machine comprising a shared folder used as a storage module of the user data used by the user virtual machine and a virtual machine comprising the specific information in the system data used by the user virtual machine;
booting the user virtual machine with the master image iun the second computing machine;
adding the specific information to the booted user virtual machine; and
referring the user data stored in the shared folder by the user virtual machine running on the second computing machine.
